(19) United States
(12) Patent Application Publication
(10) Pub. No.: US 2022/0013786 A1
(43) Pub. Date: Jan. 13, 2022

(54) POLYMER ADDITIVES AND THEIR USE IN ELECTRODE MATERIALS AND ELECTROCHEMICAL CELLS

(71) Applicants: HYDRO-QUÉBEC, Montréal, Québec (CA); MURATA MANUFACTURING CO., LTD., Nagaokakyo-shi, Kyoto (JP)

(72) Inventors: Jean-Christophe DAIGLE, St-Bruno-de-Montarville, Québec (CA); Yuichiro ASAKAWA, Court IRIS, Tokyo (JP); Karim ZAGHIB, Longueuil, Québec (CA)

(73) Assignees: HYDRO-QUÉBEC, Montréal, Québec (CA); MURATA MANUFACTURING CO., LTD., Nagaokakyo-shi, Kyoto (JP)

(21) Appl. No.: 17/279,406

(22) PCT Filed: Sep. 27, 2019
(86) PCT No.: PCT/CA2019/051389

§ 371 Date: Mar. 24, 2021

Related U.S. Application Data
(60) Provisional application No. 62/738,690, filed on Sep. 28, 2018.

(51) Int. Cl. H01M 4/62; H01M 10/0525; H01M 4/58; H01M 4/485; C08F 132/08; C08L 45/00

(52) U.S. Cl. CPC H01M 4/623; H01M 4/625; H01M 10/0525; H01M 2004/028; H01M 4/485; C08F 132/08; C08L 45/00; H01M 4/5825

(57) ABSTRACT

Described are polymers comprising norbornene-based monomeric units derived from the polymerization of norbornene-based monomers for use as electrode material additives, binder compositions comprising said polymers as additives, electrode materials comprising said polymers as additives, electrode materials comprising said binder compositions, their methods of production and their use in electrochemical cells, for instance, in lithium or lithium ion batteries.

### RELATED APPLICATION

This application claims priority under applicable laws to U.S. provisional application No. 62/738,690 filed on Sep. 28, 2018, the content of which is incorporated herein by reference in its entirety for all purposes.

### TECHNICAL FIELD

The technical field generally relates to polymer additives, polymer binders, electrode materials comprising them, their methods of production and their use in electrochemical cells.

### BACKGROUND

High-voltage electrode materials are used in high power and high energy batteries. In order to obtain high-power, high operation voltages must be applied. Conventional fluorine-containing polymer binders such as poly(vinylidene difluoride) (PVdF) exhibit excellent electrochemical stability and bonding strength. However, using fluorine-containing polymer binders at elevated operation voltages (e.g. higher than 3.8 V) may cause fluorine atoms to react and form lithium fluoride (LiF) and hydrogen fluoride (HF), leading to a progressive battery degradation and reduced electrochemical performance (e.g. cycle performance, cell impedance, capacity retention and rate capability) (Markevich, E. et al., Electrochemistry communications 7.12 (2005): 1298-1304; Zhang, Z. et al., Journal of Power Sources 247 (2014): 1-8; and Lee, S. et al., Journal of Power Sources 269 (2014): 418-423).

Therefore, the use of fluorine-free binders may be suitable to mitigate undesirable reactions (JP 2009110883A). For example, Pieczonka, N. P. W. et al., obtained a stable electrode-electrolyte interphase at the interface of a high-voltage electrode material simply by using a lithium polyacrylate (LiPAA) as a multifunctional binder. They successfully demonstrated the efficient formation of a passivation film on the high-voltage electrode material and the electronically active particles in the presence of acid groups leading to a reduction in battery degradation and a significant improvement in the electrochemical performance compared with that obtained using a traditional PVdF binder. This interphase was formed with poly(acrylic acid) (Pieczonka, N. P. W. et al., Advanced Energy Materials 5.23 (2015): 1501008).

Accordingly, there is a need for sustainable binders for high-voltage electrode materials excluding one or more of the drawbacks of conventional fluorine containing polymer binders.

### SUMMARY

According to one aspect, the present technology relates to a polymer for use as an electrode material additive, the polymer comprising norbornene-based monomeric units derived from the polymerization of a norbornene-based monomer of Formula I:

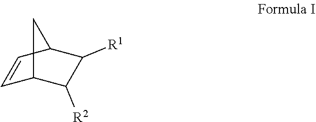

wherein,
R¹ and R² are independently in each occurrence selected from a hydrogen atom, —COOH, —SO₃H, —OH, and —F.
   In one embodiment, the polymer is of Formula II:

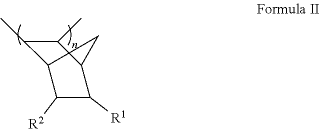

wherein,
R¹ and R² are as defined herein; and
n is an integer selected such that the number average molecular weight is from about 10 000 g/mol to about 100 000 g/mol, limits included.

In another embodiment, the polymer is a homopolymer of Formula II(a):

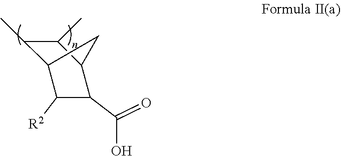

wherein,
R² and n are as defined herein.

In another embodiment, both R¹ and R² are carboxyl groups (—COOH).

According to another aspect, the present technology relates to a binder composition comprising the polymer as defined herein together with a binder. In one embodiment, the polymer is a binder additive.

In another embodiment, the binder is selected from the group consisting of a polymeric binder of polyether type, a synthetic or natural rubber, a fluorinated polymer, and a water-soluble binder.

According to another aspect, the present technology relates to the binder composition as defined herein, for use in an electrode material.

According to another aspect, the present technology relates to an electrode material comprising the polymer as defined herein and an electrochemically active material.

In one embodiment, the electrochemically active material is selected from the group consisting of metal oxide particles, lithiated metal oxide particles, metal phosphate particles and lithiated metal phosphate particles. For example, the metal is a transition metal selected from the group consisting of iron (Fe), titanium (Ti), manganese (Mn), vanadium (V), nickel (Ni), cobalt (Co) and a combination of at least two thereof. For instance, the electrochemically active material is a manganese-containing oxide or phosphate.

In another embodiment, the electrochemically active material further comprises at least one doping element (e.g. magnesium).

In another embodiment, the electrode material further comprises an electronically conductive material. For example, the electronically conductive material is selected from the group consisting of carbon black, acetylene black, graphite, graphene, carbon fibers, carbon nanofibers, carbon nanotubes, and combinations thereof. For instance, the electronically conductive material is a combination of acetylene black and carbon fibers (e.g. vapor grown carbon fibers (VGCF)).

In another embodiment, the electrode material further comprising a binder comprises the polymer as additive.

In another embodiment, the binder is selected from the group consisting of a polymeric binder of polyether type, a synthetic or natural rubber, a fluorinated polymer, and a water-soluble binder.

According to another aspect, the present technology relates to an electrode comprising the electrode material as defined herein on a current collector.

According to another aspect, the present technology relates to an electrochemical cell comprising a negative electrode, a positive electrode and an electrolyte, wherein at least one of the negative electrode or the positive electrode comprises an electrode material as defined herein.

According to another aspect, the present technology relates to an electrochemical cell comprising a negative electrode, a positive electrode and an electrolyte, wherein at least one of the positive electrode and negative electrode is as defined herein.

In one embodiment, the electrolyte is a liquid electrolyte comprising a salt in a solvent. According to one alternative, the electrolyte is a gel electrolyte comprising a salt in a solvent and optionally a solvating polymer. According to another alternative, the electrolyte is a solid polymer electrolyte comprising a salt in a solvating polymer. For example, the salt is a lithium salt.

According to another aspect, the present technology relates to a battery comprising at least one electrochemical cell as defined herein. In one embodiment, the battery is a lithium-ion battery.

### BRIEF DESCRIPTION OF THE DRAWINGS

FIGS. 1A-1B displays the electrochemical performances at different cycling rates, showing in FIG. 1A the charge capacity retention (%) results and in FIG. 1B the discharge capacity retention (%) results for Cell 1 (right, light blue filling), for Cell 2 (middle, diagonal line pattern filling), and for Cell 3 (left, black filling) as described in Example 2.

FIG. 2 displays long cycling experiments performed at 1 C and at a temperature of 45° C. effectively showing the capacity retention after 300 cycles for Cell 1 (square line) and for Cell 2 (diamond line) as described in Example 2.

FIG. 3 is a graph of the three first charge and discharge cycles performed at 1 C and a temperature of 45° C. for Cell 5 as described in Example 2.

FIG. 4 displays long cycling experiments performed at 1 C and at a temperature of 45° C. effectively showing the capacity retention after 425 cycles for Cell 5 as described in Example 2.

### DETAILED DESCRIPTION

The following detailed description and examples are illustrative and should not be interpreted as further limiting the scope of the invention.

All technical and scientific terms and expressions used herein have the same definitions as those commonly understood by the person skilled in the art when relating to the present technology. The definition of some terms and expressions used herein is nevertheless provided below for clarity purposes.

When the term “approximately” or its equivalent term “about” are used herein, it means around or in the region of. When the terms “approximately” or “about” are used in relation to a numerical value, it modifies it; for example, by a variation of 10% above and below its nominal value. This term may also take into account rounding of a number or the probability of random errors in experimental measurements, for instance, due to equipment limitations.

When a range of values is mentioned herein, the lower and upper limits of the range are, unless otherwise indicated, always included in the definition. When a range of values is mentioned in the present application then all intermediate ranges and subranges, as well as individual values included in the ranges, are intended to be included.

For more clarity, the expression “monomeric units derived from” and equivalent expressions, as used herein, refers to polymer repeat units obtained from the polymerization of a polymerizable monomer.

The chemical structures described herein are drawn according to conventional standards. Also, when an atom, such as a carbon atom as drawn, seems to include an incomplete valency, then the valency is assumed to be satisfied by one or more hydrogen atoms even if they are not necessarily explicitly drawn.

The present technology relates to polymer additives, more specifically polymer additives for use in an electrode material such as a high-voltage electrode material used for example in a lithium ion battery (LIB). The polymer additive comprises a carbon-based polymer backbone or a carbon-heteroatom-based backbone. In one variant of interest, the polymer additive comprises a carbon-based polymer backbone, for example, a cyclic or aliphatic carbon-based backbone such as a cyclic or aliphatic oleofin-based backbone, the polymer additive thus comprising an olefin-based polymer or a cycloolefin-based polymer. For example, the polymer may be a norbornene-based polymer. For example, the polymer backbone may include one or more functional groups (polar or non-polar). For example, the polymer backbone may include a hydroxyl functional group (—OH), a carboxyl group (—COOH), a sulfonic acid group (—SO₃H) or a fluorine (—F). For instance, the polymer additives may, for instance, reduce or fully suppress any parasitic reactions such as the formation of LiF and HF or other side reactions induced by the degradation of C—F bonds.

The present technology relates to a polymer for use as an electrode material additive, the polymer comprising norbornene-based monomeric units derived from the polymerization of a norbornene-based monomer of Formula I:

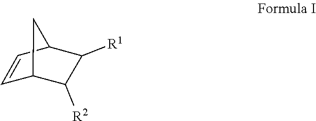

wherein,
R¹ and R² are independently in each occurrence selected from hydrogen, —COOH, —SO₃H, —OH, and —F.

According to one example, at least one of R¹ or R² is selected from —COOH, —SO₃H—OH, and —F, meaning that at least one of R¹ or R² is other than a hydrogen atom. In one example, at least one of R¹ or R² is a —COOH and the norbornene-based monomeric units are carboxylic acid-functionalized norbornene-based monomeric units. In another example, both R¹ and R² are —COOH. In another example, R¹ is —COOH and R² is a hydrogen atom. For example, the R¹ and/or R² are functional groups which may promote the dispersion of the polymer additive in the electrode material and/or provide a better adhesion of the polymer additive. For example, a better adhesion of the polymer additive on a metallic surface.

According to another example, the polymer is a norbornene-based polymer of Formula II:

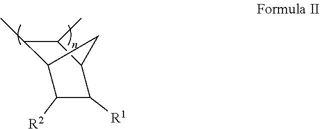

wherein R¹ and R² are as herein defined; and n is an integer selected such that the number average molecular weight is from about 10 000 g/mol to about 100 000 g/mol, limits included.

For example, a number average molecular weight from about 12 000 g/mol to about 85 000 g/mol, or from about 15 000 g/mol to about 75 000 g/mol, or from about 20 000 g/mol to about 65 000 g/mol, or from about 25 000 g/mol to about 55 000 g/mol, or from about 25 000 g/mol to about 50 000 g/mol, limits included.

According to a variant of interest, both R¹ and R² are —COOH.

According to another example, the polymer is a norbornene-based polymer of Formula II(a):

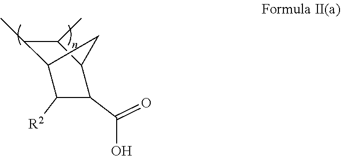

wherein R² and n are as herein defined.

According to another example, the polymer is a norbornene-based polymer of Formula II(b):

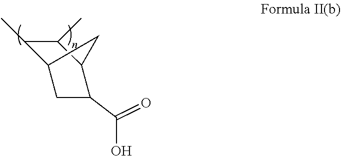

wherein n is as herein defined.

According to another example, the norbornene-based polymer of Formulae II, II(a) or II(b) is a homopolymer.

According to another example, the polymerization of the norbornene-based monomers may be accomplished by any known procedure and method of initiation, for example, without limitation, by the synthesis described by Commarieu, B. et al, (Commarieu, B. et al., Macromolecules 49.3 (2016): 920-925). For instance, the polymerization of the norbornene-based monomers may also be performed by addition polymerization.

For example, norbornene-based polymers produced by addition polymerization are highly stable under severe conditions (e.g. acidic and basic conditions). The addition polymerization of norbornene-based polymers may be performed using cheap and renewable norbornene-based monomers. For example, the glass transition temperature (T_{g}) obtained with the norbornene-based polymers produced by this polymerization route may be equal to or above 300° C., for instance, as high as 350° C.

The present technology also relates to a binder composition comprising the polymer as herein defined together with a binder.

According to one example, these polymers are contemplated for use as binder additives. For example, the ratio of binder to polymer additive is within the range of from about 6:1 to about 2:1. For example, the ratio of binder to polymer may also be from about 5.5:1 to about 2.5:1, or from about 5:1 to about 3:1, or from about 4.5:1 to about 3.5:1, limits included. For instance, the ratio of binder to polymer is about 4:1.

According to another example, the binder may be a polymer binder and may, for instance, be selected for its ability to be solubilized in a solvent that may also solubilize the polymer as defined herein and to be effectively blended therewith. For example, the solvent may be an organic solvent (e.g. N-methyl-2-pyrrolidone (NMP)). The solvent may also comprise, for example, a polar protic solvent (e.g. isopropanol) to solubilize the polymer.

Non-limiting examples of polymer binder include fluorine containing polymers (e.g. polytetrafluoroethylene (PTFE) and polyvinylidene fluoride (PVdF)), synthetic or natural rubber (e.g. ethylene propylene diene monomer rubber (EPDM)), and ion-conductive polymer binders such as a copolymer composed of at least one lithium-ion solvating segment, such as a polyether, and at least one cross-linkable segment (e.g. PEO-based polymers comprising methyl methacrylate units). According to a variant of interest, the polymer binder is a fluorine containing polymer binder. For example, the fluorine containing polymer binder is PTFE. Alternatively, the fluorine containing polymer binder is PVdF. According to another variant of interest, the polymer binder is a fluorine-free polymer binder. For example, the polymer binder is EPDM.

The present technology also relates to the use of a binder composition as defined herein, in an electrode material.

The present technology also relates to an electrode material comprising the binder composition as defined herein together with an electrochemically active material. Alternatively, the electrode material comprises the polymer as defined herein together with the electrochemically active material.

Examples of electrochemically active material includes metal oxide particles, lithiated metal oxide particles, metal phosphate particles and lithiated metal phosphate particles. For example, the metal is a transition metal, for instance, selected from the group consisting of titanium (Ti), iron (Fe), manganese (Mn), vanadium (V), nickel (Ni), cobalt (Co), and the like, or a combination thereof when applicable. Non-limitative examples of electrochemically active materials also include titanates and lithium titanates (e.g. TiO₂, Li₂TiO₃, Li₄Ti₅O₁₂, H₂Ti₅O₁₁, H₂Ti₄O₉, or a combination thereof), lithium metal phosphates and metal phosphates (e.g. LiM′PO₄ and M′PO₄ where M′ is Fe, Ni, Mn, Mg, Co, or a combination thereof), vanadium oxides (e.g. LiV₃O₈, V₂O₅, LiV₂O₅, and the like), and other lithium and metal oxides such as LiMn₂O₄, LiM″O₂ (M″ being Mn, Co, Ni, or a combination thereof), and Li(NiM′″)O₂ (M′″ being Mn, Co, Al, Fe, Cr, Ti, Zr, and the like, or a combination thereof), or a combination of any of the above materials when compatible.

In some embodiments, the electrochemically active material may be partially substituted or doped, for example, with a transition metal.

In one variant of interest, the electrode material is a positive electrode material. In one example, the electrochemically active material is a manganese-containing oxide or a manganese-containing phosphate such as those described above. In another example, the electrochemically active material is a lithium manganese oxide, wherein Mn may be partially substituted with a second transition metal, such as a lithium nickel manganese cobalt oxide (NMC). Alternatively, in one variant of interest, the electrochemically active material is a manganese-containing lithium metal phosphate such as those described above, for instance, the manganese-containing lithium metal phosphate is a lithium manganese iron phosphate (LiMn₁₋ₓFeₓPO₄, wherein x is between 0.2 and 0.5).

According to another example, the electrochemically active material may further comprise at least one doping element. For example, the electrochemically active material may be slightly doped with at least one doping element selected from a transition-metal (e.g. Fe, Co, Ni, Mn, Zn and Y), a post-transition-metal (e.g. Al) and an alkaline earth metal (e.g. Mg). For example, the electrochemically active material is magnesium-doped.

According to another example, the electrochemically active material may be in the form of particles (e.g. microparticles and/or nanoparticles) which can be freshly formed or of commercial source and may further comprise a coating material, for example, a carbon coating.

According to another example, the electrode material as described herein may further comprise an electronically conductive material. The electrode material may also optionally include additional components and/or additives like salts, inorganic particles, glass particles, ceramic particles, and the like.

Non-limiting examples of electronically conductive material include carbon black (e.g. Ketjen™ black), acetylene black (e.g. Shawinigan black and Denka™ black), graphite, graphene, carbon fibers (e.g. vapor grown carbon fibers (VGCF)), carbon nanofibers, carbon nanotubes (CNTs), and combinations thereof. For example, the electronically conductive material is acetylene black or a combination of acetylene black and VGCF.

According to another example, the electrode material as described herein may further comprise a binder (e.g. as defined above) comprising the polymer as defined herein as an additive. In one example, the polymer is a binder additive. For example, the binder to polymer ratio is as defined above.

For example, the preparation of the electrode material further comprises the use of a solvent. For example, the solvent may be an organic solvent. For instance, the organic solvent may be N-methyl-2-pyrrolidone (NMP). The solvent may also comprise a polar protic solvent (e.g. isopropanol). The slurry obtained after mixing the electrode material in the solvent may be applied on a substrate (e.g. a current collector) and then dried to substantially remove the solvent.

The present technology thus also relates to an electrode comprising the electrode material as defined herein on a current collector. For example, the electrode is a negative electrode or a positive electrode. According to a variant of interest, the electrode is a positive electrode.

The present technology also relates to an electrochemical cell comprising a negative electrode, a positive electrode and an electrolyte, wherein at least one of either the negative electrode or the positive electrode is as defined herein. In one variant of interest, the positive electrode is as defined herein.

The present technology also relates to an electrochemical cell comprising a negative electrode, a positive electrode and an electrolyte, wherein at least one of either the negative electrode or the positive electrode comprises an electrode material as defined herein. In one variant of interest, the positive electrode comprises an electrode material as defined herein.

According to another example, the electrolyte may be selected for its compatibility with the various elements of the electrochemical cell. Any compatible electrolyte may be contemplated. According to one example, the electrolyte may be a liquid electrolyte comprising a salt in an electrolyte solvent. Alternatively, the electrolyte may be a gel electrolyte comprising a salt in an electrolyte solvent which may further comprise a solvating polymer. For example, a liquid or a gel electrolyte may further be impregnating a separator. Alternatively, the electrolyte may be a solid polymer electrolyte comprising a salt in a solvating polymer.

In one example, the salt may be a lithium salt. Non-limiting examples of lithium salt include lithium hexafluorophosphate (LiPF₆), lithium bis (trifluoromethanesulfonyl) imide (LiTFSI), lithium bis (fluorosulfonyl) imide (LiFSI), lithium 2-trifluoromethyl-4,5-dicyanoimidazolate (LiTDI), lithium 4,5-dicyano-1,2,3-triazolate (LiDCTA), lithium bis (pentafluoroethylsulfonyl) imide (LiBETI), lithium tetrafluoroborate (LiBF₄), lithium bis (oxalato) borate (LiBOB), lithium nitrate (LiNO3), lithium chloride (LiCl), bromide of lithium (LiBr), lithium fluoride (LiF), lithium perchlorate (LiClO₄), lithium hexafluoroarsenate (LiAsF₆), lithium trifluoromethanesulfonate (LiSO₃CF₃) (LiTf), lithium fluoroalkylphosphate Li [PF₃(CF₂CF₃)₃] (LiFAP), lithium tetrakis (trifluoroacetoxy) borate Li[B(OCOCF₃)₄] (LiTFAB), lithium bis (1,2-benzenediolato (2-)—O,O′) borate [B(O₆O₂)_{2]} (LBBB) and combinations thereof. According to one variant of interest, the lithium salt is LiPF₆.

For example, the electrolyte solvent is a non-aqueous solvent. Non-limiting examples of non-aqueous solvents include cyclic carbonates such as ethylene carbonate (EC), propylene carbonate (PC), butylene carbonate (BC), and vinylene carbonate (VC); acyclic carbonates such as dimethyl carbonate (DMC), diethyl carbonate (DEC), ethylmethyl carbonate (EMC), and dipropyl carbonate (DPC); lactones such as γ-butyrolactone (γ-BL) and γ-valerolactone (γ-VL); chain ethers such as 1,2-dimethoxyethane (DME), 1,2-diethoxyethane (DEE), ethoxymethoxyethane (EME), trimethoxymethane, and ethylmonoglyme; cyclic ethers such as tetrahydrofuran, 2-methyltetrahydrofuran, 1,3-dioxolane and dioxolane derivatives; and other solvents such as dimethylsulfoxide, formamide, acetamide, dimethylformamide, acetonitrile, propylnitrile, nitromethane, ethylmonoglyme, phosphoric acid triester, sulfolane, methylsulfolane, propylene carbonate derivatives and mixtures thereof. According to one variant of interest, the non-aqueous solvents is a mixture of two or more carbonates such as PC/EMC/DMC (4/3/3).

According to another example, the electrolyte is a gel polymer electrolyte. The gel polymer electrolyte may include, for example, a polymer precursor and a salt (e.g. as defined above), a solvent, and a polymerization and/or crosslinking initiator when required. Examples of gel electrolytes include, without limitation, gel electrolytes described in PCT application numbers WO2009/111860 (Zaghib et al.) and WO2004/068610 (Zaghib et al.).

According to another example, the electrolyte is a solid polymer electrolyte (SPE). For example, the SPE may be selected from any known SPE and is selected for its compatibility with the various elements of the electrochemical cell. For instance, the SPE may be selected for its compatibility with lithium. SPEs may generally comprise one or more solid polar polymers, optionally cross-linked, and a salt (e.g. as defined above). Polyether-type polymers such as those based on poly(ethylene oxide) (PEO) may be used, but several other compatible polymers are known for the preparation of SPEs and are also considered. The polymer may also be further crosslinked. Examples of such polymers include star-shaped or comb-shaped multi-branch polymers such as those described in PCT application no WO2003/063287 (Zaghib et al.).

According to another example, the electrolyte as described herein may further comprise at least one electrolyte additive. The electrolyte additive may be selected from any known electrolyte additive and may be selected for its compatibility with the various elements of the electrochemical cell. In one example, the electrolyte additive is a dicarbonyl compound such as those described in PCT application no WO2018/116529 (Asakawa et al.), for example, the electrolyte additive may be poly(ethylene-alt-maleic anhydride) (PEMA).

The present technology further relates to a battery comprising at least one electrochemical cell as defined herein. For example, said battery is selected from a lithium battery, a lithium-sulfur battery, a lithium-ion battery, a sodium battery, and a magnesium battery. In one variant of interest, said battery is a lithium-ion battery.

According to another example the electrochemical cell as defined herein may have an improved electrochemical performance (e.g. cyclability and/or capacity retention) compared to electrochemical cells not including the present additive. For example, the use of a binder additive as defined herein may significantly improve the capacity retention and/or the cycle performance even under harsh operating conditions such as high operating voltages and higher temperatures compared to electrochemical cells comprising a conventional binder (e.g. PVdF) without the present additive.

### EXAMPLES

The following non-limiting examples are illustrative embodiments and should not be construed as further limiting the scope of the present invention. These examples will be better understood when referring to the accompanying Figures.

### Example 1: Preparation of Electrode Materials and Electrochemical Cells

A carboxylic acid functionalized norbornene-based polymer (PBNE-COOH) produced by addition polymerization was obtained from a commercial source and used as an electrode binder additive in LiMn_{0.75}Fe_{0.20}Mg_{0.06}PO₄-lithium titanate (Li₄Ti₅O₁₂, LTO) cells with a liquid electrolyte consisting of 1 M lithium hexafluorophosphate (LiPF₆) in a carbonate solvent mixture comprising PC/EMC/DMC (4/3/3). The LiMn_{0.75}Fe_{0.20}Mg_{0.05}PO₄ was further coated with carbon (i.e. C—LiMn_{0.75}Fe_{0.20}Mg_{0.05}PO₄). The cell configurations are presented in Table 1.

TABLE 1
Cell configurations

| | | | | Cell 2 | | Cell 3 | | | |
|---|---|---|---|---|---|---|---|---|---|
| | | Cell 1 | | Control cell | | Control cell | | Cell 4 | |
| | | with | | without | | without | | with | |
| Electrode | Material | PBNE-COOH | | PBNE-COOH | | PBNE-COOH | | PBNE-COOH | |
| Positive | Electrochemically active material | 90 | wt. % | 90 | wt. % | 90 | wt. % | 90 | wt. % |
| electrode | (C—LiMn_{0.75}Fe_{0.20}Mg_{0.05}PO₄) | | | | | | | | |
| | Electronically conductive | 4 | wt. % | 4 | wt. % | 4 | wt. % | 4 | wt. % |
| | material 1 (Acetylene black) | | | | | | | | |
| | Electronically conductive | 1 | wt. % | 1 | wt. % | 1 | wt. % | 1 | wt. % |
| | material 2 (VGCF) | | | | | | | | |
| | Binder (PVdF) | 4 | wt. % | 5 | wt. % | 5 | wt. % | 4 | wt. % |
| | PBNE-COOH | 1 | wt. % | — | | — | | 1 | wt. % |
| | Volume density (loadings) | 1.4 | mgcm⁻³ | 1.4 | mgcm⁻³ | 1.8 | mgcm⁻³ | 1.8 | mgcm⁻³ |
| Negative | Electrochemically active material | 90 | wt. % | 90 | wt. % | 90 | wt. % | 90 | wt. % |
| electrode | (Li₄Ti₅O₁₂) | | | | | | | | |
| | Electronically conductive | 5 | wt. % | 5 | wt. % | 5 | wt. % | 5 | wt. % |
| | material (Acetylene black) | | | | | | | | |
| | Binder (PVdF) | (5 | wt. %) | 5 | wt. % | 5 | wt. % | 5 | wt. % |

All cells were assembled in coin cell casings with the above components, polyethylene-based separators and aluminum current collectors. Cells 2 and 3 were prepared without the PBNE-COOH binder additive for comparative purposes.

2 Ah pouch-type lithium-ion cells were also assembled and electrochemically tested. The PBNE-COOH as described herein was used as an electrode binder additive in a LiMn_{0.75}Fe_{0.20}Mg_{0.06}PO₄-LTO cell with a liquid electrolyte consisting of 1 M LiPF₆ in a carbonate solvent mixture comprising PC/EMC/DMC (4/3/3). The liquid electrolyte further comprised 0.5% PEMA as an electrolyte additive as described in PCT application no WO2018/116529 (Asakawa et al.). The LTO was further carbon-coated (C-LTO) and was prepared as described in PCT application no WO2018/000099 (Daigle et al.). The cell configurations are presented in Table 2.

TABLE 2
Cell configuration

| | | Cell 5 | |
|---|---|---|---|
| | | with | |
| Electrode | Material | PBNE-COOH | |
| Positive | Electrochemically active material | 90 | wt. % |
| electrode | (C—LiMn_{0.75}Fe_{0.20}Mg_{0.05}PO₄) | | |
| | Electronically conductive material 1 (Acetylene black) | 4 | wt. % |
| | Electronically conductive material 2 (VGCF) | 1 | wt. % |
| | Binder (PVdF) | 4 | wt. % |
| | PBNE-COOH | 1 | wt. % |
| | Mass loading per area | 8 | mg/cm² |
| | Volume density (loading) | 1.8 | mg/cm³ |
| Negative | Electrochemically active material (C-LTO) | 90 | wt. % |
| electrode | Electronically conductive material (Acetylene black) | 5 | wt. % |
| | Binder (PVdF) | (5 | wt. %) |

The cell was assembled in 2 Ah pouch-type lithium-ion cell with the above components, a polyethylene-based separator and aluminum current collectors.

### Example 2: Electrochemical Properties

This example illustrates the electrochemical behavior of the electrochemical cells presented in Example 1.

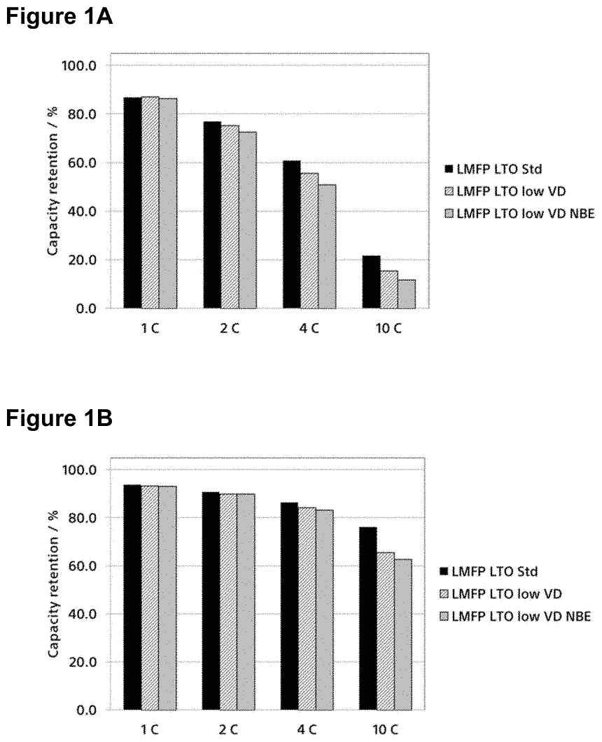

FIGS. 1A-1B display the electrochemical performances at different cycling rates showing in (A) the charge capacity retention (%) results and in (B) the discharge capacity retention (%) results for Cell 3 (left-black filling), for Cell 2 (middle-diagonal line filling pattern) and for Cell 1 (right-blue filling). The charge and discharge were preformed at 1 C, 2 C, 4 C and 10 C and recorded at a temperature of 25° C. FIGS. 1A-1B effectively show that when 1 wt. % of PNBE-COOH is used as a binder additive, the binder additive has a minor effect on the capacity retention at high cycling rate (4 C and 10 C), similar results are recorded at 1 C and 2 C.

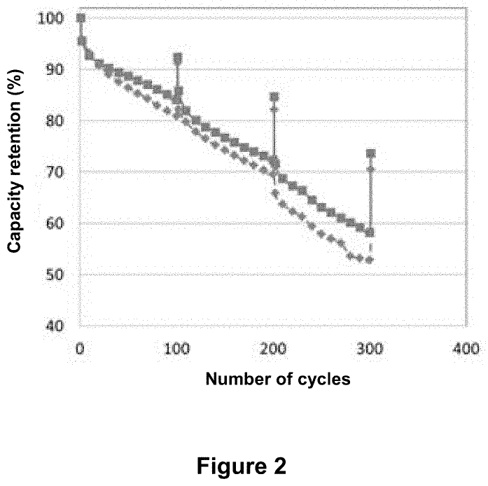

FIG. 2 displays long cycling experiments performed at 1 C and at a temperature of 45° C. effectively showing the capacity retention after 300 cycles for Cell 1 (square line) and for Cell 2 (diamond line). Under these conditions, the capacity retention after 100 cycles at a temperature of 45° C. of the cells comprising 1 wt. % of PNBE-COOH (Cell 1) was higher by about 3.7% when compared with cells comprising a PVdF binder not including the present additive (Cell 2).

Table 3 presents the initial capacity, the capacity after 300 cycles and the capacity retention (%) recorded during a long cycling experiment performed at 1 C and at a temperature of 45° C. Table 3 effectively displaying an improved capacity retention for Cell 4 comprising 1 wt. % of PNBE-COOH as a binder additive and PVdF as a binder compared to Cell 3 (a control cell not including the present additive) comprising PVdF as a binder.

TABLE 3
Capacity retention during cycle test at 1 C (45° C.)

| | Initial capacity | Capacity at 300 cycles | Capacity retention |
|---|---|---|---|
| | (mAh) | (mAh) | (%) |
| Cell 3 | 2.59 | 1.81 | 70 |
| Cell 4 | 2.63 | 1.94 | 74 |

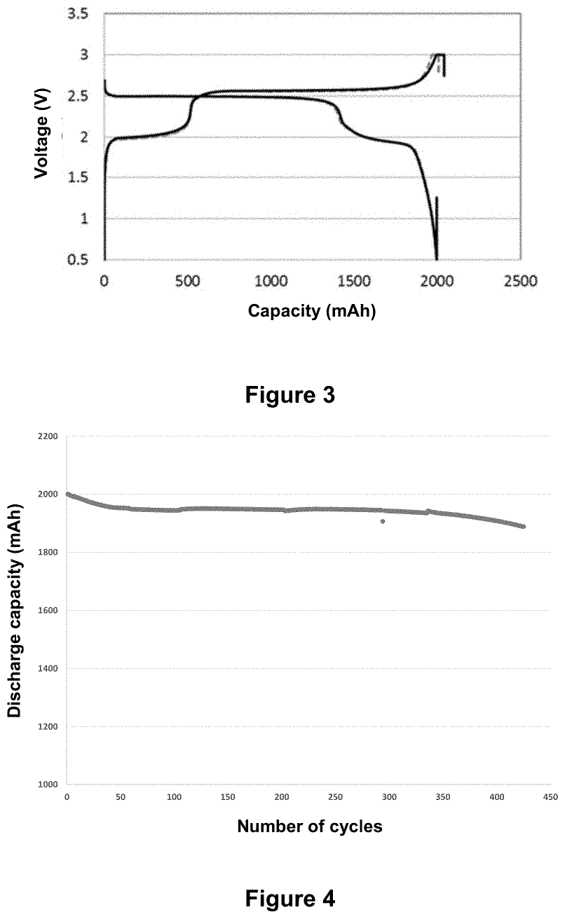

FIG. 3 is a graph showing the three first charge and discharge cycles performed at 1 C and at a temperature of 45° C., effectively a graph of the voltage versus the capacity (mAh) for Cell 5.

FIG. 4 displays long cycling experiments performed at 1 C and at a temperature of 45° C. effectively a graph of the discharge capacity (mAh) versus the cycle number and showing the capacity retention after 425 cycles for Cell 5.

Table 4 presents the gravimetric energy density (Wh/kg), the volumetric energy density (Wh/L) energy density, the gravimetric power density (Wh/kg), the volumetric power density (Wh/L), and the capacity retention after 425 cycles recorded during a long cycling experiment performed at 1 C and at a temperature of 45° C. for Cell 5.

TABLE 4
Results for Cell 5

| | Gravimetric | Volumetric | Gravimetric | Volumetric | Capacity |
|---|---|---|---|---|---|
| | energy density | energy density | power density | power density | retention |
| | (Wh/kg) | (Wh/L) | (Wh/kg) | (Wh/L) | (%) |
| Cell 5 | 92 | 171 | 1923 | 3571 | 86 |

Numerous modifications could be made to any of the embodiments described above without distancing from the scope of the present invention. Any references, patents or scientific literature documents referred to in the present application are incorporated herein by reference in their entirety for all purposes.

1. A polymer for use as an electrode material additive, the polymer comprising norbornene-based monomeric units derived from the polymerization of a norbornene-based monomer of Formula I: 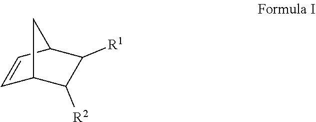
wherein,
W and W are independently in each occurrence selected from a hydrogen atom, —COOH, —SO₃H, —OH, and —F.

2. The polymer of claim 1, wherein said polymer is of Formulae II or II(a): 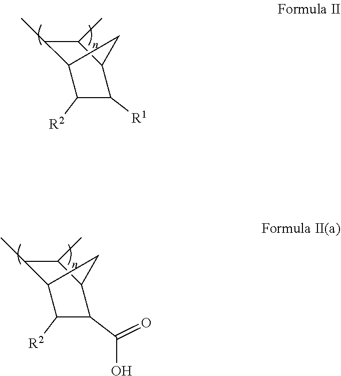
wherein,
R¹ and R² are as defined in claim 1, preferably R² is —COOH or a hydrogen atom; and
n is an integer selected such that the number average molecular weight is from about 10 000 g/mol to about 100 000 g/mol, or from about 12 000 g/mol to about 85 000 g/mol, or from about 15 000 g/mol to about 75 000 g/mol, or from about 20 000 g/mol to about 65 000 g/mol, or from about 25 000 g/mol to about 55 000 g/mol, or from about 25 000 g/mol to about 50 000 g/mol, limits included.

3-6. (canceled)

7. The polymer of claim 1, wherein the polymer is a homopolymer.

8. A binder composition comprising the polymer as defined in claim 1 together with a binder.

9. The binder composition of claim 8, wherein the polymer is a binder additive.

10. The binder composition of claim 8, wherein the weight ratio of binder to polymer is within the range of from about 6:1 to about 2:1.

11. The binder composition of claim 8, wherein the binder is selected from the group consisting of a polymeric binder of polyether type, a fluorinated polymer, and a synthetic or natural rubber, preferably wherein the binder is a fluorinated polymer, preferably polytetrafluoroethylene (PTFE) or polyvinylidene fluoride (PVdF), or the binder is a synthetic or natural rubber, preferably an ethylene propylene diene monomer rubber (EPDM).

12-16. (canceled)

17. The binder composition of claim 8, for use in an electrode material.

18. An electrode material comprising the polymer as defined in claim 1 and an electrochemically active material.

19. The electrode material of claim 18, wherein the electrochemically active material is selected from the group consisting of metal oxide particles, lithiated metal oxide particles, metal phosphate particles and lithiated metal phosphate particles, wherein the metal is preferably a transition metal selected from the group consisting of iron (Fe), titanium (Ti), manganese (Mn), vanadium (V), nickel (Ni), cobalt (Co) and a combination of at least two thereof, and more preferably the electrochemically active material is a manganese-containing oxide or phosphate.

20-21. (canceled)

22. The electrode material of claim 18, wherein the electrochemically active material further comprises at least one doping element (e.g. magnesium).

23. The electrode material of claim 18, further comprising an electronically conductive material preferably selected from the group consisting of carbon black, acetylene black, graphite, graphene, carbon fibers, carbon nanofibers, carbon nanotubes, and combinations thereof, and more preferably the electronically conductive material is a combination of acetylene black and carbon fibers (e.g. vapor grown carbon fibers (VGCF)).

24-25. (canceled)

26. The electrode material of claim 18, further comprising a binder comprising the polymer as an additive, wherein the ratio of binder to polymer is preferably within the range of from about 6:1 to about 2:1.

27. (canceled)

28. The electrode material of claim 26, wherein the binder is selected from the group consisting of a polymeric binder of polyether type, a synthetic or natural rubber, and a fluorinated polymer, preferably wherein the binder is a fluorinated polymer, preferably polytetrafluoroethylene (PTFE) or polyvinylidene fluoride (PVdF), or the binder is a synthetic or natural rubber, preferably an ethylene propylene diene monomer rubber (EPDM).

29-33. (canceled)

34. An electrode comprising the electrode material as defined in claim 18 on a current collector.

35. An electrochemical cell comprising a negative electrode, a positive electrode and an electrolyte, wherein at least one of the negative electrode or the positive electrode comprises an electrode material as defined in claim 18.

36. An electrochemical cell comprising a negative electrode, a positive electrode and an electrolyte, wherein at least one of the positive electrode and negative electrode is as defined in claim 34.

37. The electrochemical cell of claim 35, wherein the electrolyte is a liquid electrolyte comprising a salt in a solvent, or a gel electrolyte comprising a salt in a solvent and optionally a solvating polymer, or a solid polymer electrolyte comprising a salt in a solvating polymer, and wherein the salt is preferably a lithium salt.

38-40. (canceled)

41. A battery comprising at least one electrochemical cell as defined in claim 35, wherein said battery is preferably a lithium-ion battery.

42. (canceled)

43. The electrochemical cell of claim 36, wherein the electrolyte is a liquid electrolyte comprising a salt in a solvent, or a gel electrolyte comprising a salt in a solvent and optionally a solvating polymer, or a solid polymer electrolyte comprising a salt in a solvating polymer, and wherein the salt is preferably a lithium salt.

44. A battery comprising at least one electrochemical cell as defined in claim 36, wherein said battery is preferably a lithium-ion battery.
